(19) United States
(12) Patent Application Publication
(10) Pub. No.: US 2002/0072973 A1
(43) Pub. Date: Jun. 13, 2002

(54) Method for providing services

(76) Inventor: Hidetaka Magoshi, Palo Alto, CA (US)

Correspondence Address: KATTEN MUCHIN ZAVIS ROSENMAN, 575 MADISON AVENUE, NEW YORK, NY, 10022-2585, US

(21) Appl. No.: 09/973,671

(22) Filed: Oct. 9, 2001

(30) Foreign Application Priority Data
Dec. 7, 2000 (JP) 2000-372359
Aug. 27, 2001 (JP) 2001-256709

(51) Int. Cl. G06F 17/60

(52) U.S. Cl. 705/14

(57) ABSTRACT

Sets fees of service beneficiaries according to the frequency (and or the quantity) of advertising to be added to services provided. With this arrangement, it is possible to provide services in the mode added with the fee and advertising that the service beneficiaries want.

This application is related to Japanese Patent Application No. 2000-372359 filed on Dec. 7, 2000, and No. 2001-256709 filed on Aug. 27, 2001, based on which this application claims priority under the Paris Convention and the contents of which are incorporated herein by reference.

### BACKGROUND OF THE INVENTION

1. Field of the Invention

The present invention relates to a method of providing services, a program for providing services, a computer-readable recording medium recorded with a program for providing services, an apparatus for executing a program, a contents distribution system, a contents distribution program, and a computer-readable recording medium recorded with a contents distribution program, that are suitable for application to toll viewer services of television broadcasting like ground wave broadcasting, satellite broadcasting, and cable televisions, connection services and contents distribution services for a communication line network like the Internet, and product distribution services.

2. Description of the Related Art

Nowadays, there have been known various kinds of television broadcasting like a ground wave broadcasting using a ground wave, a satellite broadcasting using a satellite, and a cable broadcasting using cables, and various kinds of programs like sports, movies, news, etc. have been broadcast.

The costs of broadcasting these programs and costs of preparing the programs are borne by the viewers or are borne by program sponsors, depending on the types of broadcasting. For example, in the case of national broadcasting, a constant subscription fee is charged to each viewer every month. The national broadcasting station broadcasts programs and prepares programs based on the fees collected from the viewers.

On the other hand, in the case of private broadcasting, program sponsors are invited. Commercial advertising fees are charged to the sponsors subject to the condition that the commercial advertising of the sponsors is inserted during the broadcasting of the programs. A private broadcasting station broadcasts programs and prepares programs based on the commercial advertising fees collected from the sponsors. In the case of this private broadcasting, the sponsors pay the subscription fees for the viewers. Therefore, the viewers can watch the programs basically without the need for paying the subscription fees.

However, in the case of the private broadcasting, while the viewers can watch programs free of charge as the sponsors pay for the commercial advertising fees, the viewers are substantially forced to watch the commercial advertising of the sponsors. When the frequency of commercial advertising during a program is high, the flow of a series of the program is interrupted, and the viewers find difficulty in enjoying the program. Further, when the quantity of broadcasting commercial advertising during a program becomes large, the program is interrupted for a long time. Therefore, the viewers also find difficulty in enjoying the program.

Under these circumstances, some viewers feel that they can pay subscription fee if the quantity of broadcasting commercial advertising were to be decreased. In converse, it is also a fact that some viewers can accept the broadcasting of commercial advertising if the subscription fees can be reduced or is made free of charge.

This kind of subject relating to the provision of services and the quantity of advertising similarly applies to a case of the contents that users observe via the communication line network like the Internet, for example, and banner advertising inserted (displayed) in the contents.

### SUMMARY OF THE INVENTION

The present invention has been achieved in the light of the above problems. It is, therefore, an object of the invention to provide a method of providing services, a program for providing services, a computer-readable recording medium recorded with a program for providing services, an apparatus for executing a program, a contents distribution system, a contents distribution program, and a computer-readable recording medium recorded with a contents distribution program, that are capable of providing services at fees and in an advertising mode selected by service beneficiaries.

In order to meet the above object by solving the above problems, the one aspect of the present invention sets a fee to be charged to service beneficiaries according to the frequency (and or quantity) of advertising added to the services provided. With this arrangement, it is possible to provide services at the fee and in the advertising mode that the service beneficiaries want.

Other and further objects and features of the present invention will become obvious upon understanding of the illustrative embodiments about to be described in connection with the accompanying drawings or will be indicated in the appended claims, and various advantages not referred to herein will occur to one skilled in the art upon employing of the invention in practice.

### BRIEF DESCRIPTION OF DRAWINGS

FIG. 1 is a block diagram of a contents distribution system according to an embodiment of the present invention.

FIG. 2 is a flowchart for explaining the operation of registering the frequency and the quantity of advertising in the contents distribution system according to the embodiment.

FIG. 3 is a diagram for explaining a charged fee corresponding to the frequency and the quantity of advertising.

FIG. 4 is a diagram for explaining user information stored in a user information database of a server system that constitutes the contents distribution system according to this embodiment.

FIG. 5 is a flowchart for explaining a distribution operation of contents and advertising information in the contents distribution system according to this embodiment.

### DETAILED DESCRIPTION OF THE PREFERRED EMBODIMENTS

Various embodiments of the present invention will be described with reference to the accompanying drawings. It is to be noted that the same or similar reference numerals are applied to the same or similar parts and elements throughout the drawings, and the described of the same or similar parts and elements will be omitted or simplified.

The present invention can be applied to a contents distribution system for broadcasting various kinds of programs such as, for example, news programs, programs of sports, and variety shows.

### Structure of the System

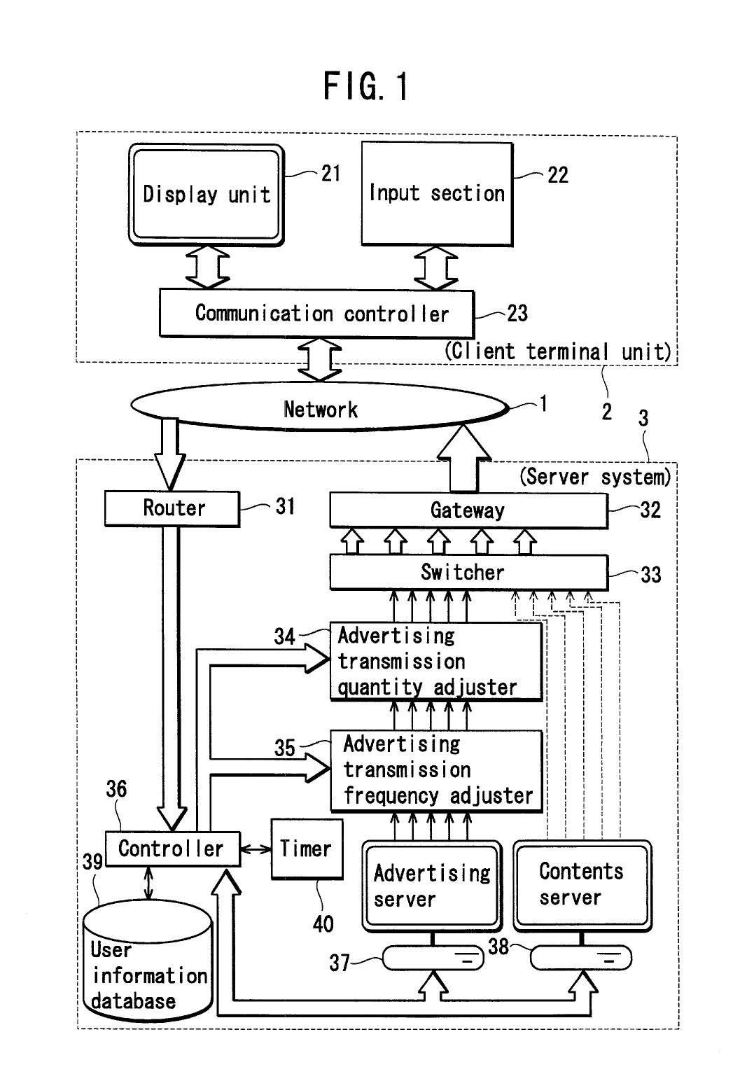

FIG. 1 is a block diagram of a contents distribution system according to an embodiment of the present invention. In FIG. 1, a contents distribution system of this embodiment has a client terminal unit 2, and a server system 3 at a broadcasting station side that transmits contents of various kinds of programs to this client terminal unit 2. The client terminal unit 2 and the server system 3 are connected to each other via a network 1.

The network 1 means a total communications network that utilizes the electric communications technique. This network 1 includes a communication line network like the Internet using the TCP (Transmission Control Protocol)/IP (Internet Protocol) as a base, a WAN (Wide Area Network) and a LAN (Local Area Network), for example, and other networks like a television broadcasting network using a ground wave, a satellite communications network, and a cable communications network.

When the contents are distributed from the server system 3 at the broadcasting station side via the Internet, for example, the client terminal unit 2 becomes a personal computer having a Web browser and a contents processing function. When the contents are distributed using a ground wave from the server system 3 at the broadcasting station side, the client terminal unit 2 becomes a television receiver.

In the following explanation, in order to facilitate the understanding, it is assumed that the client terminal unit 2 is a personal computer, and this client terminal unit 2 receives the distribution services of various kinds of contents that are distributed from the server system 3 at the broadcasting station side via the Internet as the network 1.

### Structure of the Server System

In this case, the server system 3 has a router 31, a gateway 32, a switcher 33, an advertising transmission quantity adjuster 34, an advertising transmission frequency adjuster 35, a controller 36, an advertising server 37, and a contents server 38.

The router 31 has a function of connecting the server system 3 and the client terminal unit 2 to each other via the network 1. For example, it is possible to use an ISDN router corresponding to an ISDN (Integrated Services Digital Network) line, and a software router for realizing a router function with software. This router 31 can be replaced with the gateway 32 to be explained below.

The gateway 32 has a function of connecting the server system 3 and the client terminal unit 2 to each other via the network 1, basically in a similar manner to that of the router 31. While the router 31 makes a mutual connection in a network layer (a third layer) of an OSI (Open Systems Interconnection) basic reference model, the gateway 32 can correspond to the protocols of all the layers of the OSI basic reference model. Therefore, by using the gateway 32, it becomes possible to realize a network connection processing for wider application.

The advertising server 37 stores advertising information like commercial advertising, character advertising, and banner advertising. The contents server 38 stores program information (contents) like news programs, programs of sports, and variety shows, for example. The advertising information and the contents are compressed and encoded according to the compressed encoding technique like the MPEG2 (MPEG: Moving Picture Experts Group) , and the compressed and encoded results are stored in the servers 37 and 38.

The advertising transmission quantity adjuster 34 thins the advertising information output from the advertising server 37 for a predetermined period of time according to an instruction from the controller 36, thereby to adjust the transmission quantity of the advertising information per one time. This advertising information transmission quantity shows a transmission time of the advertising information.

The advertising transmission frequency adjuster 35 adjusts the transmission frequency of the advertising information output from the advertising server 37 according to an instruction from the controller 36. The frequency of the advertising information shows the number of advertising information transmitted per unit time.

The switcher 33 inserts the advertising information of the frequency and the quantity adjusted by the advertising transmission quantity adjuster 34 and the advertising transmission frequency adjuster 35 into the contents output from the contents server 38, or combines the advertising information with the contents. Then, the switcher 33 distributes this advertising information to the client terminal unit 2 via the gateway 32 and the network 1.

When the user does not want the distribution of this advertising (that is, when the user pays the subscription fee for the contents distribution services without advertising), the switcher 33 operates so as not to insert the advertising information into the contents from the contents server 38 or combine the advertising information with the contents.

The controller 36 has a user information database 39, and stores the frequency and the quantity of advertising assigned by each user, into this user information database 39. At the time of distributing the contents, the controller 36 reads each user information showing the frequency and the quantity of advertising assigned by the corresponding user, forms contents that are inserted with or combined with the advertising information of the frequency and the quantity corresponding to this information, and distributes the resultant information to the client terminal unit 2. The controller 36 also counts time with a timer 40, and monitors the time of distributing the advertising.

### Structure of the Client Terminal Unit

The client terminal unit 2 has a structure of a personal computer in this case. The client terminal unit 2 has a display unit 21 like a cathode ray tube (CRT) or a liquid crystal display (LCD) for displaying the contents (and the advertising information) distributed from the server system 3, a input section 22 like a keyboard and a mouse for assigning a selection of desired contents, and the transmission frequency and transmission quantity of the advertising information, and a communications controller 23 for carrying out the control of communications between the client terminal unit 2 and the server system 3.

### Operation of the Contents Distribution System

According to this embodiment, the contents distribution system selects the frequency and the quantity of advertising in advance when the viewer receives the contents of a desired program. At the broadcasting station side, the contents distribution system forms and distributes the contents inserted with the advertising of the frequency and the quantity selected by the viewer. Then, the contents distribution system charges the viewer for the subscription fee corresponding to the frequency and the quantity of advertising added to the contents.

The explanation will be progressed below based on the assumption that each time when the viewer watches a program, the viewer selects the frequency and the quantity of advertising added to this program. This may be arranged as follows. The viewer assigns in advance the desired frequency and quantity of advertising that the viewer wants, to the broadcasting station. The broadcasting station adds the adverting of the frequency and the quantity assigned in advance by the viewer, and then distributes the contents of the program, without asking the viewer to assign the frequency and the quantity of advertising at the time of distributing the contents of the program.

### Registration of Frequency and Volume of Advertising

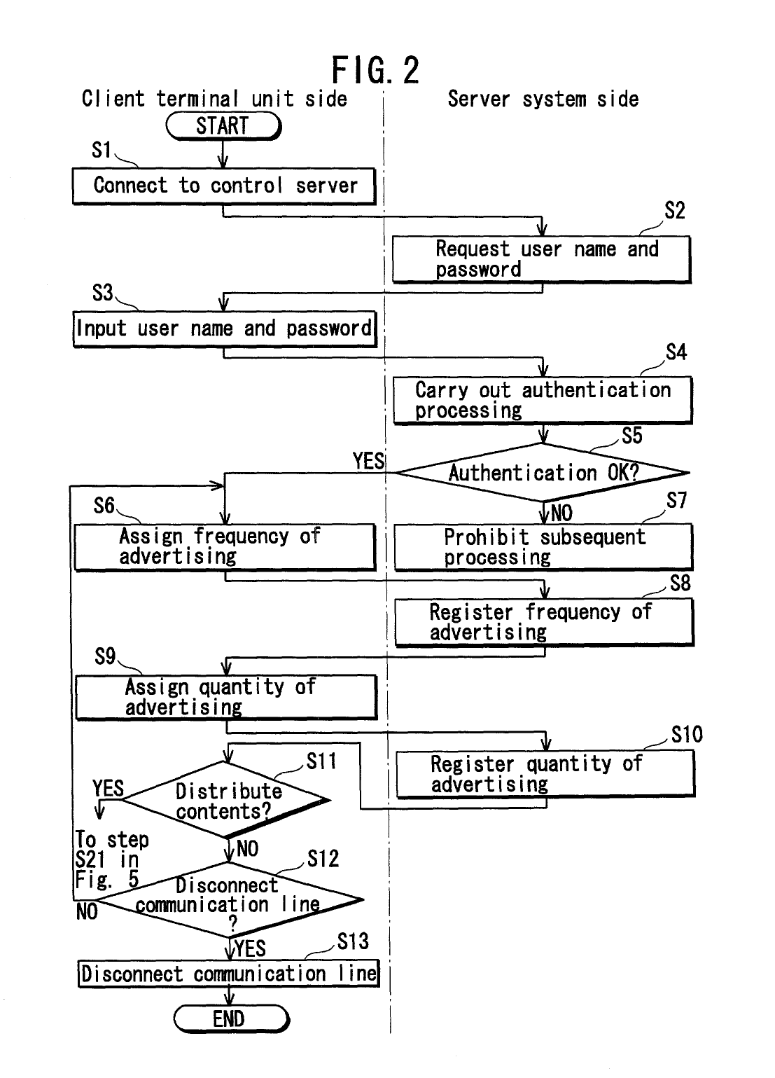

A flowchart in FIG. 2 shows a flow of operation that the viewer registers the frequency and the quantity of advertising that the viewer wants, to the broadcasting station. In the flowchart shown in FIG. 2, steps S1, S3, S6, S9, and S11 to S13 show the operation of the viewer at the client terminal unit 2 side, and steps S2, S4, S5, S7, S8, and S10 show the operation of the broadcasting station at the server system 3 side.

According to this contents distribution system, first, the viewer who is going to receive the distribution of desired contents from the broadcasting station selects the frequency and the quantity of advertising to be inserted into the contents.

Namely, when the viewer is about to receive the distribution of desired contents from the broadcasting station, the viewer turns on the main power source to the own client terminal unit 2. When the main power source of this client terminal unit 2 has been turned on, the flowchart shown in FIG. 2 starts, and the process proceeds to step S1.

At step S1, the viewer starts the Web browser of the client terminal unit 2, and operates the input section 22 to try to connect the client terminal unit 2 to the server system 3 at the broadcasting station side. As a result, the client terminal unit 2 is connected to the server system 3 via the network 1, and the processing routine of this flowchart proceeds to step S2.

At step S2, the controller 36 of the server system 3 requests the client terminal unit 2 that has established the connection to the server system 3, to input a user name and a password. Then, the processing routine of this flowchart proceeds to step S3.

At step S3, the viewer at the client terminal unit 2 side operates the input section 22 to input the user name and the password allocated to the self. When the user name and the password have been input, the client terminal unit 2 transmits the user name and the password to the server system 3. Then, the processing routine of this flowchart proceeds to step S4.

At step S4, the controller 36 of the server system 3 collates the user name and the password input by this viewer with a user name and a password stored in the user information database 39, and proceeds to step S5. At step S5, the system server 3 carries out the authentication processing for making a decision about whether the viewer who wants the distribution of the contents at present is a legal member of this system or not.

When a decision has been made that the viewer who wants the distribution of the contents at present is a legal member of this system (in the case of Yes), the controller 36 requests the viewer to assign the frequency and the quantity of advertising. When a decision has been made that the viewer who wants the distribution of the contents at present is not a legal member of this system (in the case of No), the controller 36 transmits an error message of “The input user name or password is not legal”, for example, to the client terminal unit 2, and prohibits the execution of subsequent processing, at step S7.

Next, at step S6 and step S9, the viewer operates the input section of the client terminal unit 2 to assign the frequency and the quantity of advertising to be added to the contents of which distribution the viewer wants. When the viewer has assigned the frequency and the quantity of advertising, the client terminal unit 2 transmits the information on the assigned frequency and quantity of advertising to the system server 3.

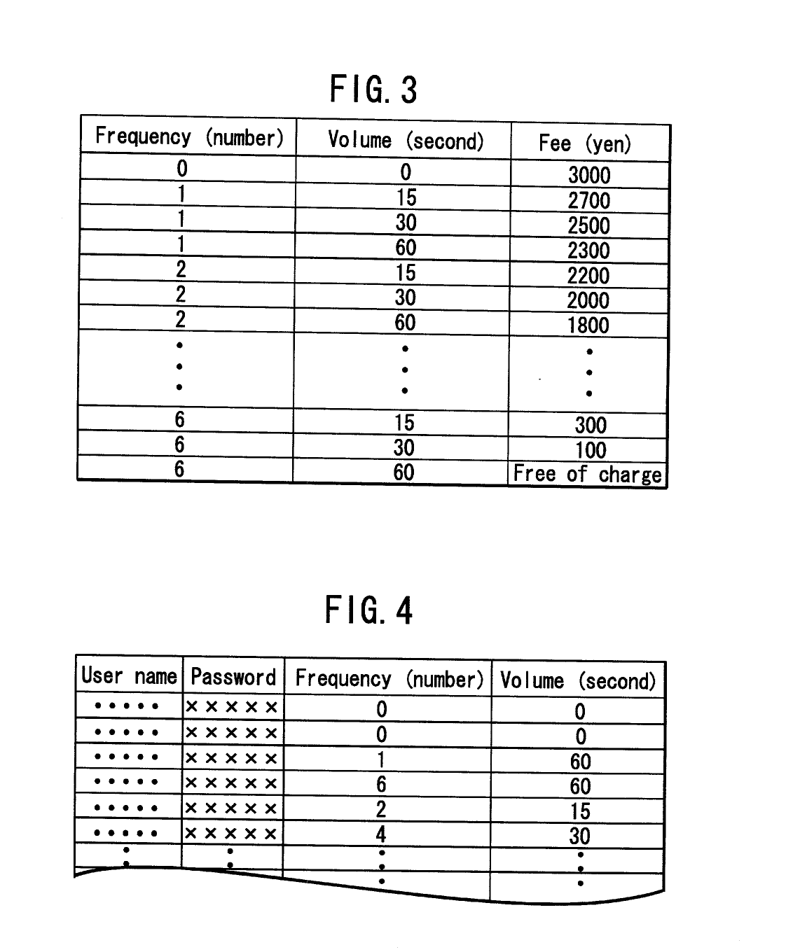

FIG. 3 is a diagram showing a charged fee of contents corresponding to the frequency and the quantity of advertising assigned by the user. In the example shown in FIG. 3, regarding the frequency of advertising, a desired level of frequency is selected from among 0 time to 6 times per contents at one time. Regarding the quantity of advertising, a desired quantity is selected from among 15 seconds, 30 seconds, and 60 seconds per one time.

When the frequency of advertising has been assigned to 0 (zero) time (= no advertising. In this case, the quantity is zero second), for example, the user must bear the total amount of the subscription fee of the contents. Therefore, the subscription fee is a maximum amount of 3,000 yen, for example. When the viewer has assigned the frequency of advertising to one time, and has also assigned the advertising time to 15 seconds per one time, the subscription fee is discounted to 2,700 yen by deducting 300 yen that corresponds to the adverting time of 15 seconds from the maximum amount of 3,000 yen. Similarly, when the viewer has assigned the frequency of advertising to two times, and has also assigned the advertising time to 60 seconds per one time, the subscription fee is discounted to 1,800 yen by deducting 1,200 yen that corresponds to the adverting time of 60 seconds × two times from the maximum amount of 3,000 yen. Further, when the viewer has assigned the frequency of advertising to six times, and has also assigned the advertising time to 60 seconds per one time, the subscription fee becomes zero yen (free of charge) as a result of deducting 3,000 yen that corresponds to the adverting time of 60 seconds × six times from the maximum amount of 3,000 yen.

As explained above, according to the contents distribution system of this embodiment, subscription fees of the contents have been determined at stages corresponding to the frequency and the quantity of advertising to be selected by the viewer. Therefore, the viewer selects the desired frequency and quantity of advertising by referring to these subscription fees.

Next, when the desired frequency and quantity of advertising have been selected by the user, the controller 36 at the server side stores the frequency and the quantity of advertising selected by the user, into the user information database 39, at step S8 and step S10.

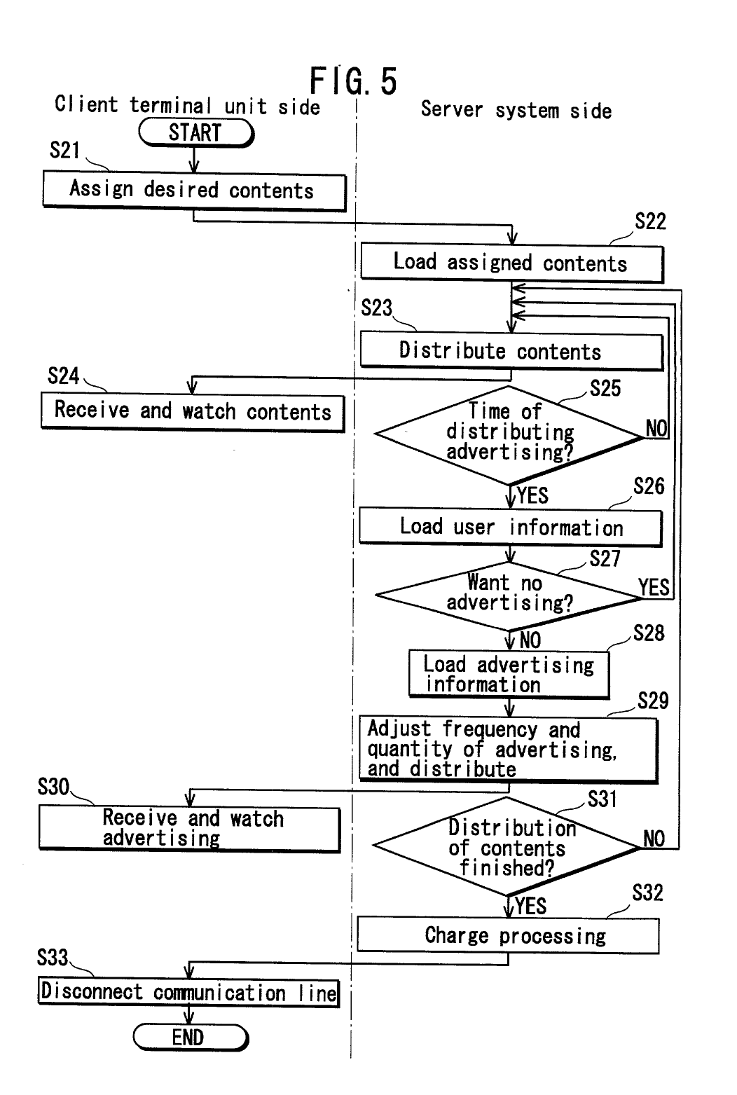

FIG. 4 is a diagram showing one example of information on the frequency and the quantity of adverting stored for each user in the user information database 39. As understood from FIG. 4, the user information database 39 stores the information on the frequency and the quantity of adverting selected by each user, like the frequency of advertising zero time and the quantity zero second, or the frequency of advertising one time and the quantity 60 seconds, for example, together with the user name and the password of each user. The information that shows the frequency and the quantity of advertising for each user stored and controlled in the user information database 39 is read by the controller 36 at the time of distributing advertising. Then, the controller 36 transmits the advertising information to the client terminal unit 2 of each user, based on the frequency and the quantity of adverting selected by each user.

Next, when the frequency and the quantity of adverting have been assigned, the communications controller 23 at the client terminal unit 2 side displays on the display unit 21 a message of asking whether the distribution of the contents is to be started or not like “Do you want the distribution of the contents to be started?”, for example. Then, at step S11, the server system 3 decides whether the distribution of the contents has been assigned from the user or not. When the distribution of the contents has been assigned from the user, the operation shifts to the flowchart in FIG. 5 that shows the distribution of the contents and the advertising information. When the distribution of the contents has not been assigned from the user, the process proceeds to step S12.

At step S12, the communications controller 23 at the client terminal unit 2 side displays on the display unit 21 a message of asking whether the connection status of the communication line between the client terminal unit 2 and the server system 3 is to be maintained or not like “Do you want the connection line to be disconnected?”, for example. When the connection is not to be disconnected, the server system 3 regards that there is a correction in the assignment of the frequency and the quantity of advertising, then returns to step S6. Then, each routine at step S6 to step S11 is executed repeatedly.

On the other hand, when the user has assigned the disconnection of the communication line, the communication controller 23 disconnects the communication line between the client terminal unit 2 and the server system 3 at step S13. As a result, all the routines of the flowchart shown in FIG. 2 are finished.

### Distribution of Contents and Advertising

Next, when the user has assigned the distribution of the contents at step S11 in the flowchart shown in FIG. 2, the operation of the system shifts to the operation of the flowchart shown in FIG. 5 that shows the flow of the distribution of the contents and advertising.

In the flowchart shown in FIG. 5, when the user has assigned desired contents, the client terminal unit 2 transmits information showing the contents assigned by the user to the server system 3 at step S21.

At the server system 3 side, the controller 36 loads the contents assigned by the user from the contents server 38 at step S22. At step S23, the server system 3 distributes the contents to the client terminal unit 2 via the switcher 33 and the gateway 32. Based on this, at the client terminal unit 2 side, it becomes possible to watch the desired contents as shown at step S24.

Next, the server system 3 monitors the time of distributing the advertising by counting time with the timer 40 while distributing the contents. At step S25, the controller 36 makes a decision about whether the current time has reached the time of distributing the advertising or not, based on the time counted with the timer 40. When the current time has not reached the time of distributing the advertising, the process returns to step S23, and the controller 36 continues to control the distribution of the contents. When the current time has reached the time of distributing the advertising, the process proceeds to step S26.

At step S26, as the current time has reached the time of distributing the advertising, the controller 36 loads the user information of the user to whom the contents are being distributed, from the user information database 39. With this arrangement, the controller 36 detects the frequency and the quantity of advertising assigned by the user.

At step S27, the controller 36 makes a decision about whether the user wants non-distribution of the advertising information (no advertising) or not, based on the loaded user information. When the user wants no advertising, the process returns to step S23, and the controller 36 continues to control the distribution of the contents. With this arrangement, the user can watch the contents continuously without being interrupted by advertising, as desired.

Next, when the user has permitted the distribution of the advertising information, at step S28, the controller 36 reads the predetermined advertising information from the advertising server 37, and loads this advertising information to the advertising transmission frequency adjuster 35 and the advertising transmission quantity adjuster 34 respectively.

At step S29, the controller 36 controls the advertising transmission frequency adjuster 35 and the advertising transmission quantity adjuster 34 to form the advertising information of the frequency and the quantity assigned in advance by the user. Then, the controller 36 interrupts the transmission of the contents from the contents server 38, and controls the change-over of the switcher 33 to distribute the advertising information adjusted by the advertising transmission frequency adjuster 35 and the advertising transmission quantity adjuster 34. This advertising information is transmitted to the client terminal unit 2 via the gateway 32. As a result, the user watches the advertising information of the frequency and the quantity assigned by the user himself or herself (step S30).

The controller 36 controls the change-over of the switcher 33 to re-start the distribution of the contents so far interrupted, after the distribution of this advertising information. As a result, the user can watch the rest of the contents continuously after watching the advertising.

Next, at step S31, the controller 36 makes a decision about whether the distribution of the contents has been finished or not. When the distribution of the contents has not yet been finished, the process returns to step S23, and the controller 36 continues to control the distribution of the contents. When the distribution of the contents has been finished, the process proceeds to step S32, and the controller 36 charges the user for the subscription fee of the contents.

As described with reference to the example shown in FIG. 3, the subscription fees of the contents are decided at stages based on the frequency and the quantity of advertising. Therefore, at step S32, the controller 36 charges the user for the subscription fee corresponding to the frequency and the quantity of advertising selected by the user from among the frequencies and quantity of advertising determined at stage.

Next, when the user has finished the watching of the contents, the user disconnects the communication line connected between the client terminal unit 2 and the server system 3, at step S33. As a result, all the routines of the flowchart shown in FIG. 5 are finished.

As is apparent from the above explanation, according to the contents distribution system of this embodiment, this system makes the user select in advance the frequency and the quantity (or the frequency or the quantity) of advertising to be added to the contents. Then, the contents distribution system charges the user for the subscription fee corresponding to the frequency and the quantity of advertising selected by the user. With this arrangement, it is possible to distribute the contents in the form of the subscription fee and the advertising quantity desired by the user.

In the above explanation of the embodiment, the advertising information of the frequency and the quantity selected in advance by the user is inserted. However, it is also possible to change the frequency and the quantity of adverting in the middle of the distribution of the contents. In this case, the user operates the input section 22 of the client terminal unit 2 to assign the change in the frequency and the quantity of advertising. Then, the server system 3 distributes the advertising information of the frequency and the quantity that have been changed, and charges the user for the subscription fee corresponding to the frequency and the quantity of advertising changed by the user.

Further, the above embodiment shows an example of the case where the present invention is applied to the contents distribution system that distributes the contents via the communication line. It is also possible to apply the present invention to a connection service like the toll broadcasting using the ground wave or the satellite wave and the Internet. When the present invention has been applied to the connection service like the Internet, the user is made to select the frequency and the quantity of banner advertising that is displayed on the display screen, and the user is charged for the connection fee corresponding to the frequency and the quantity of advertising selected by the user.

The present invention may be applied to an object distribution system. In the case of the object distribution system, an object is wrapped with a wrapping paper, and the wrapped object is distributed. Therefore, the user is charged for a distribution fee corresponding to the position and quantity of advertising attached to the wrapping paper.

The above-described embodiment is one example of the present invention. Therefore, it should be noted that the present invention is not limited to the above embodiment, and it is of course possible to carry out various modifications according to designs or the like within the range not deviating from the technical idea of the present invention.

What is claimed is:

1. A method of providing services, comprising the steps of:
making service beneficiaries select at least one of the frequency and the quantity of advertising to be added to the services provided; and
setting a fee for the provision of services to the service beneficiaries, according to at least one of the frequency and the quantity of advertising selected.

2. The method of providing services according to claim 1, wherein
the fees including free of charge for the services to be provided to the service beneficiaries are set at stages, according to at least one of the frequency and the quantity of advertising selected.

3. The method of providing services according to claim 1, wherein
at least one of the frequency and the quantity of advertising selected can be changed during the provision of the services.

4. A computer-readable recording medium recorded with a service-providing program, the service-providing program comprising and making a computer execute the steps of:
making service beneficiaries select at least one of the frequency and the quantity of advertising to be added to the services provided; and
setting a fee for the provision of services to the service beneficiaries, according to at least one of the frequency and the quantity of advertising selected.

5. The computer-readable recording medium recorded with a service-providing program according to claim 4, wherein
the fees including free of charge for the services to be provided to the service beneficiaries are set at stages, according to at least one of the frequency and the quantity of advertising selected.

6. The computer-readable recording medium recorded with a service-providing program according to claim 4, wherein
at least one of the frequency and the quantity of advertising selected can be changed during the provision of the services.

7. A program-executing apparatus for executing a computer program, the computer program comprising the steps of:
making service beneficiaries select at least one of the frequency and the quantity of advertising to be added to the services provided; and
setting a fee for the provision of services to the service beneficiaries, according to at least one of the frequency and the quantity of advertising selected.

8. The program-executing apparatus according to claim 7, wherein
the fees including free of charge for the services to be provided to the service beneficiaries are set at stages, according to at least one of the frequency and the quantity of advertising selected.

9. The program-executing apparatus according to claim 7, wherein
at least one of the frequency and the quantity of advertising selected can be changed during the provision of the services.

10. A contents distribution system, comprising:
a client terminal unit connected to a predetermined network, and having selecting means for selecting at least one of the frequency and the quantity of advertising to be added to the contents to be distributed; and
a distribution unit having distribution means for distributing the contents added with the advertising corresponding to at least one of the frequency and the quantity selected by the selecting means of the client terminal unit, to the client terminal unit via the predetermined network, and charging means for charging a fee for the contents distributed to the client terminal unit, according to at least one of the frequency and the quantity of advertising selected by the selecting means of the client terminal unit.

11. The contents distribution system according to claim 10, wherein
the charging means sets the fees including free of charge for the services to be provided at stages, according to at least one of the frequency and the quantity of advertising selected by the selecting means of the client terminal unit.

12. The contents distribution system according to claim 10, wherein
the client terminal unit has changing means for assigning a change in at least one of the frequency and the quantity of advertising during the reception of the contents, and
the distribution means of the distribution unit adds the advertising according to at least one of the frequency and the quantity changed by the changing means of the client terminal unit, and distributes the contents added with the advertising to the client terminal unit.

13. A computer-readable recording medium recorded with a contents distribution program, the contents distribution program comprising and making a computer execute the steps of:
making a client terminal unit connected to a predetermined network select at least one of the frequency and the quantity of advertising to be added to the contents to be distributed;
making a distribution unit connected to the predetermined network add the advertising corresponding to at least one of the frequency and the quantity selected by the client terminal unit to the contents, and distribute the contents added with the advertising to the client terminal unit; and
making the distribution unit charge a fee for the contents distributed to the client terminal unit, according to at least one of the frequency and the quantity of advertising selected by the client terminal unit.

14. The computer-readable recording medium recorded with a contents distribution program according to claim 13, the contents distribution program further comprising and making a computer execute the step of:
making the distribution unit set fees including free of charge for the contents at stages, according to at least one of the frequency and the quantity of advertising selected by the client terminal unit.

15. The computer-readable recording medium recorded with a contents distribution program according to claim 13, the contents distribution program further comprising and making a computer execute the step of:
making the client terminal unit assign a change in at least one of the frequency and the quantity of advertising during the reception of the contents, and
making the distribution unit add the advertising according to at least one of the frequency and the quantity changed by the client terminal unit, and distribute the contents added with the advertising to the client terminal unit.

16. A service-providing program, comprising and making a computer execute the steps of:
making service beneficiaries select at least one of the frequency and the quantity of advertising to be added to the services provided; and
setting a fee for the provision of services to the service beneficiaries, according to at least one of the frequency and the quantity of advertising selected.

17. A contents distribution program comprising and making a computer execute the steps of:
making a client terminal unit connected to a predetermined network select at least one of the frequency and the quantity of advertising to be added to the contents to be distributed;
making a distribution unit connected to the predetermined network add the advertising corresponding to at least one of the frequency and the quantity selected by the client terminal unit to the contents, and distribute the contents added with the advertising to the client terminal unit; and
making the distribution unit charge a fee for the contents distributed to the client terminal unit, according to at least one of the frequency and the quantity of advertising selected by the client terminal unit.
